(19) United States
(12) Patent Application Publication
(10) Pub. No.: US 2005/0170721 A1
(43) Pub. Date: Aug. 4, 2005

(54) Insulation product having antimicrobial/antifungal facing, and facing for same

(76) Inventors: Murray S. Toas, Norristown, PA (US); Kenneth Knapp, Norristown, PA (US)

Correspondence Address: DUANE MORRIS, LLP;IP DEPARTMENT, ONE LIBERTY PLACE, PHILADELPHIA, PA, 19103-7396, US

(21) Appl. No.: 10/772,063

(22) Filed: Feb. 4, 2004

(51) Int. Cl. B32B 3/00; B32B 5/02; B32B 5/16; B32B 27/20; B32B 27/04; B32B 27/12; B32B 23/02

(52) U.S. Cl. 442/149; 442/59; 442/74; 442/123; 442/165

(57) ABSTRACT

Insulation products having cellulosic facing or facings are provided in which the facing is treated with an antifingal or antimicrobial agent in an amount so as to act effectively in reducing microorganisms such as mold or fungus. In the preferred processes of this invention, an antimicrobial or antifungal additive, and preferably a biocide, is added to a paper slurry precursor of the cellulosic facing so as to provide the finished facing with antimicrobial or antifungal properties.

### FIELD OF INVENTION

The present invention relates to inorganic fiber insulation products having one or more facings thereon, and more particularly, to inorganic fiber insulation mats or batts having a cellulosic facing adhered to at least one major surface thereof, wherein at least the facing has been treated or made to have antimicrobial and/or antifungal properties.

### BACKGROUND OF THE INVENTION

Batt insulation is commonly manufactured by fiberizing mineral fibers from a molten mineral bath by forcing molten glass through a spinner rotating at a high number of revolutions per minute. The fine fibers are then contacted by a pressurized hot gas to draw the fibers to a useable diameter and length. The fibers are typically sprayed with a heat-curable phenolic resin binder. The fibers are then collected and distributed on a conveyor to form a mat or blanket. The phenolic resin is then cured in a curing oven. The mat is then sliced into lengthwise strips having desired widths and chopped into individual batts and rolls. In some cases, a facing material, such as Kraft paper coated on one side with a hot, tacky bituminous material or other vapor retarder, is joined to the mat prior to the chopping step.

One of the potential problems associated with installing glass fiber insulation materials is that paper facing layers may exhibit fungal growth when exposed to microbiological organisms, especially in wet or damp areas, such as basements or under a roof. Attempts have been made to make mold-resistant and antimicrobial paper products for various purposes, see U.S. Pat. Nos. 3,981,766; 3,998,944; and 4,533,435; which are hereby incorporated herein by reference. However, major manufacturers have, for some time, been reluctant to advertise mold resistant insulation batts.

In the paper industry, it is important to prevent or retard the growth of organisms such as fungi, mildew, algae, protozoa and bacteria, in water or aqueous liquids. Biocides, such as fungicides, are used in minute quantities, such as 0.1 to 4.0 pounds¹ per ton of pulp and paper produced, to reduce the growth of such organisms on pulp processing equipment in paper mills. Biocides tend to be poorly water soluble, and so require special compositions for application in an intended use. Additionally, biocides often are organic solvents which are noxious, toxic to fish and wildlife, volatile, flammable and subject to regulation by government authorities. While some of these same biocides have been added to paper, by adding much larger quantities of biocide, for example, about 5.0 to 20.02 pounds per ton of dry fiber produced, to the hydropulper or dump chest, such additions are not very cost effective and require proportional increases in safety precautions to preserve the health of humans and domestic animals.
^{1,2}These dosages, and those mentioned herein, are those recommended on the label for Spectrum® RX31000, which has 15% active ingredients and is available from Hercules, Corp. If 100% active ingredients is assumed, these loadings would presumably be lower.

Accordingly, there is a present need for a mold and/or microbe resistant building insulation, and especially a batt insulation having a mold-resistant cellulosic facing which can be manufactured safely and inexpensively.

### SUMMARY OF THE INVENTION

The present invention provides building insulation, including a cellulosic facing, comprising at least one antifungal/antimicrobial agent, bonded to an insulation layer comprising randomly oriented inorganic fibers bonded together with a binder. The preferred cellulosic facing exhibits no significant fungal growth when tested in accordance with ASTM C-1338 or other standard test methods, such as ASTMD-2020 and TAPPI-T487, for determining fungi resistance of insulation materials and facings. Such test methods typically test for microbes such as Aspergillus Niger, Aspergillus Versicolor, Penicillium Funculosum, Chaetomium Globosum, Aspergillus Flavus and (optionally) Stachybotrys Chartarum.

In a further development of this invention, a process for preparing an antifungal/antimicrobial resistant faced insulation product is provided. The process includes preparing an insulation layer comprising randomly oriented inorganic fibers bonded by a resinous binder, the insulation layer having a first and a second major surface thereon. The process further includes the step of adhering a cellulosic facing layer to at least a first of the major surfaces. The cellulosic facing layer contains an amount of an antifungal or antimicrobial compound to act as an antifungal or antimicrobial agent.

In a further embodiment of this invention, a method of controlling the growth of fungi or mildew on a cellulosic facing of an insulation product is provided. The method includes increasing the amount of biocide used in a fiber slurry precursor of the cellulosic facing to achieve a sufficient level of biocide in said cellulosic facing to resist fungi or mildew growth.

In more preferred embodiments of this invention, the biocide selected to be used in the paper making process is methylene-bis-thiosyanate combined with dodecylguanidine-hydrochloride, which is preferably added to the paper facing to provide a level of at least about 3 parts per million (“ppm”). This range provides an acceptable kill rate of the most common microorganisms for slime control, while simultaneously providing mold and mildew resistance to cellulosic facings in accordance with ASTM C-1338.

The preferred antifungal/antimicrobial compound of this invention is desirably heat resistant to a minimum temperature of approximately 250° F., and more preferably, to approximately 350° F., for maintaining its antifungal/antimicrobial properties despite the application of hot bituminous coating materials, such as hot asphalt, to the preferred Kraft facing. The bituminous adhesive is generally used when hot and tacky to marry the bottom surface of a lane of mineral fiber insulation traveling on a conveyor to a cellulosic or Kraft facing material. The bituminous coating also acts as a vapor retarder for the insulation product during insulation and use. The preferred antifungal/antimicrobial agent is nontoxic and noncarcinogenic when said facing of said insulation is contacted by humans, as for example, during transportation and installation of building insulation.

The most preferred cellulosic facing material is Kraft paper which, typically, has a basis weight of about 20-60 lbs. per 3000 ft². The preferred biocides of this invention have the ability of providing slime reduction in paper and pulp processing equipment, as well as providing resistance to fungi or mildew growth in cellulosic facing materials used in connection with the building insulation of this invention. Some of the materials which are acceptable as slimicides and antifungal/antimicrobial agents for the facing include: chlorine, organo-mecurials, chlorinated phenols, organo-bromides, organo-sulphur compounds, copper sulfate, 2, 4, 4′-trichloro-2′ hydroxydiphenol (Microban®), 5-chloro-2-(2,4-dichlorophenoxy) phenol; diiodomethyl-p-tolylsulfone; 2-bromo-2 nitropropane-1,3-diol (BNPD); sodium 2-pyridinethiol-1-oxide (PEO); 2-(thiocyano-methyl thio) benzothiazole (TCMTB), 3-iodo-2 propynyl-butyl carbamate; phenyl-(2-cyano-2 chlorovinyl) sulfone; N,N-dimethyl-N′-phenyl-(N′-fluorodichloromethylthio) sulfamide; 2,2-dibromo-2-nitrilopropionamide; 3,4-dicholoro-1,2-dithiol-3-one; N-4-dihydroxy-alpha-oxobenzene-ethanimidoyl chloride; methylene-bis-thiocyanate; dodecylguanidine hydrochloride; sodium 2-pyridinethiol-1-oxide; trihaloalkyl sulfone; bis (trichloro methyl) sulfone (BTCMS), chlorhexidine; polyhexamethylene biguanide (PHMB), glutaraldehyde, a mixture of 5-chloro-2-methyl-4-isothiazolin-3-one+2-methyl-4-isothiazolin-3-one and derivations, homologues and combinations thereof.

In still a further embodiment of this invention, a process for preparing an antifungal/antimicrobial faced insulation product is provided, which includes the steps of (a) preparing an insulation layer comprising randomly oriented inorganic fibers bonded by a resinous binder, the insulation layer having first and second major surfaces thereon; and (b) adhering a cellulosic facing layer to at least a first of the major surfaces, the cellulosic facing layer containing an amount of an antifungal or antimicrobial agent which is sufficient to act as an antifungal or antimicrobial agent. Preferably, this insulation product is a faced mineral fiber batt which may include an antifungal or antimicrobial agent added to the cellulosic facing layer during or after the making of the cellulosic facing layer. More preferably, the antifungal or antimicrobial agent is a biocide which is added to a paper slurry precursor of said cellulosic facing layer, for example, in quantities of about 3-180 ppm. The biocide can be added to at least one of a paper making stock tank, paper refiner, stock chest, flow box, furnish, wet lap, hydropulper, dump chest, size press, water box, or a combination of these locations, used in making the cellulosic facing. Alternatively, the biocide might be added to at least one of pulp, broke, polymer, de-foamer, alum, emulsions, adhesives, paper mill coatings, pigment slurries, paper products, or a combination thereof, used to make the cellulosic facing.

In an unexpected development, the biocide level can be selected to be significantly below 200 ppm of the dry weight of the cellulosic facing, which is under the 200 ppm generally deemed necessary in order to achieve mold resistance in paper stock, such as in accordance with mold test procedures ASTM C-1338.

The ASTM C-1338 standard test method for determining fungi resistance of insulation materials and facings is a known standard. An insulation and/or facing can pass the test if mold growth on it is less than a comparative material—a white birch tongue depressor or southern yellow pine tongue depressor. Test fungi are selected to include Aspergillus Niger, Aspergillus Versicolor, Penicillium Funculosum, Chaetomium Globosum, Aspergillus Flavus. The specimens are treated with 10⁵ spores/specimen, 28 day test at 30° C. and 95% relative humidity. Results are measured by observing the growth of organisms to the naked eye.

### BRIEF DESCRIPTION OF THE DRAWINGS

The accompanying drawings illustrate preferred embodiments of the invention, as well as other information pertinent to the disclosure, in which:

FIG. 1 is a side elevation diagrammatical view of an insulation product of this invention; and

FIG. 2 is a schematic side elevation view of a process for producing the insulation product of FIG. 1.

### DETAILED DESCRIPTION OF THE INVENTION

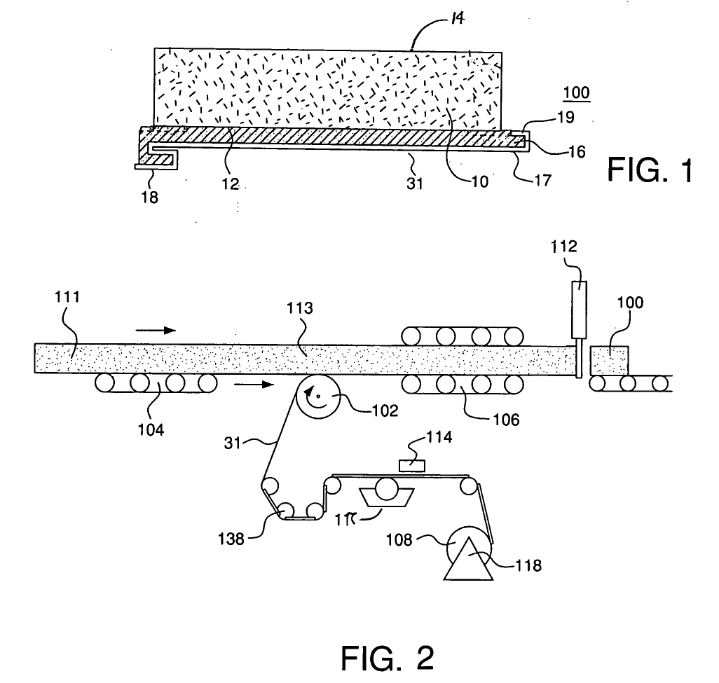

With reference to the Figures, and more particularly to FIG. 1 thereof, there is shown an insulation product 100. Insulation product 100 includes an insulation blanket or mat 10 formed from randomly oriented organic and/or inorganic fibers bonded together with a binder. Organic fibers such as polymeric fibers, such as nylon, polypropylene, etc., or inorganic fibers such as rotary glass fibers, textile glass fibers, stonewool (also known as rockwool), or a combination thereof are still suitable selections. Mineral fibers, such as glass, are preferred. The thickness of the insulation blanket or mat 10 is generally proportional to the insulation's effectiveness or “R-value” of the insulation. A facing layer 17, which may be a polymeric film or typically formed from a cellulosic layer, such as Kraft paper, coated with a bituminous material or layer 16, thus providing a vapor retarder, is provided on the first major surface 12, second major surface 14, or on both surfaces, and or one or more side portions of the insulation blanket or mat 10. The facing layer 17 and bituminous layer 16 together form, in the preferred embodiment, bitumen-coated Kraft paper 31. In batt insulation 100, a pair of side tabs 18 and 19, are provided which can be unfolded and fastened to wooden or metal studs, for example. The batt insulation may also be provided without tabs. Various known configurations for side tabs or flaps 18 and 19 are known. The facing layer 17 can be vapor impermeable or permeable, depending on its makeup, degree of perforation, degree of coating, and intended use.

The insulation blanket or mat 10 is typically formed from glass fibers, often bound together with a resinous phenolic binder material, or melted thermoplastic, fibrous or powdered material. The insulation is typically compressed after manufacture and packaged, so as to minimize the volume of the product during storage and shipping and to also make handling and installation of the insulation product easier. After the packaging is removed, a plurality of batt insulation products 100 tend to quickly “fluff up” to their prescribed label thickness for installation.

Insulation intended for thermally insulating buildings typically has a low glass fiber density, such as from about 0.4 to 1.5 pounds (see fn. 1 and 2) per cubic foot (6.4×kg/m³ to 24×kg/m³), and often employs a vapor barrier, e.g., 20-60 lb. per 3000 ft² of dry paper, preferably 40-43 lb. per 3000 ft², Kraft paper facing available from Canfor Ltd., Canada, and subsequently coated on one side with a bituminous material. The bituminous coating is preferably applied in a sufficient amount so as to provide an effective retarder for water vapor, for example, so as to reduce the water vapor permeability of the preferred Kraft paper to no more than about one perm when tested by ASTM E96 Method A test procedure. In other forms, where a vapor retarder is not desired, the insulation blanket or mat 10 can have no facing on its second major surface 12. Optionally, the cellulosic facing layer 17 can be secured to the bottom of major surface 12 of the insulation blanket or mat 10 by an adhesive, such as a hot-melt resinous adhesive.

A process for producing the batt insulation 100 of FIG. 1 is shown schematically in FIG. 2. A continuous glass fiber blanket or mat 111 formed in a conventional manner is presented by a feed conveyer 104 to a heated roll 102, to which is simultaneously supplied a continuous web of bituminous-coated Kraft paper web 31, fed between the heated roll 102 and the glass fiber mat 111. The web of Kraft paper fed via roller 102 of FIG. 2, is supplied from a roll 108 on payout stand 118, through an accumulator 138 for tensioning the Kraft paper web 31. In addition, the outside surface of the web can be marked at a marking station 114 with identifying information such as the R-value of the glass fiber mat and the production lot code before the Kraft paper web 31 is applied to the bottom of the glass fiber mat 111. Preferably, the edges of the Kraft paper web 31 are folded over to form the side tabs 18, 19 (FIG. 1) just prior to the web being contacted by the heated roll 102. The Kraft paper web 31 is oriented so that the bituminous-coated side of the Kraft paper web 31 faces the bottom of the glass fiber mat 111. The temperature of the liquid bituminous coating material is preferably greater than 250° F., and more preferably about 350° F., so as to be tacky enough to adhere the Kraft paper web 31 to the underside of the glass fiber mat 111.

This process can be alternatively accomplished by applying hot bituminous coating to the Kraft paper in situ by an optional coating station 117 shown in FIG. 2, located near the continuous batt forming line. The faced glass fiber mat 111 is transported away from the heated roll 102 by a tractor section 106, and delivered to a chopper 112, which periodically chops the faced glass fiber mat 111 to form insulation batts 100. The insulation batts 100 so formed are then transported to packaging equipment (not shown).

Bituminous-coated Kraft paper facing is the most widely used facing material for batt insulation products, and is desirable for the facing layer 17. Kraft paper is a commodity and is typically made a by wet-slurry process on a foraminous belt which allows water to be drained away from the slurry to produce a wet mat. Further calendaring or rolling of this mat produces a continuous sheet of paper. The preferred paper facing is 40-43 lbs/3000 ft² Kraft paper from Canfor, Ltd. of Canada.

The facing layer or layers of this invention can also be, for example, spun-bonded or meltblown nonwoven materials alone, or polymer fibers mixed with paper fiber. In certain embodiments of this invention, the facing layer 17 can be a highly porous membrane, which enables quick air escape from the batt under conditions of rapid compression, such as during packaging, or a water vapor impervious polymeric layer or film.

In pulp and paper mill systems, such as those used in manufacturing Kraft paper, slime formed by microorganisms is commonly encountered. Fouling of equipment due to slime build up can cause breakouts on the paper machines and consequent work stoppages, loss of production time, and/or blemishes in the final product. These problems have resulted in extensive utilization of biocides in pulp and paper mill systems. Materials which have enjoyed widespread use in such applications also include chlorine, organo-mecurials, chlorinated phenols, organo-bromides, organo-sulphur compounds, copper sulfate, 2, 4, 4′-trichloro-2′ hydroxydiphenol (Microban®), 5-chloro-2-(2,4-dichlorophenoxy) phenol; diiodomethyl-p-tolylsulfone; 2-bromo-2 nitropropane-1,3-diol (BNPD); sodium 2-pyridinethiol-1-oxide (PEO); 2-(thiocyano-methyl thio) benzothiazole (TCMTB), 3-iodo-2 propynyl-butyl carbamate; phenyl-(2-cyano-2 chlorovinyl) sulfone; N,N-dimethyl-N′-phenyl-(N′-fluorodichloromethylthio) sulfamide; 2,2-dibromo-2-nitrilopropionamide; 3,4-dicholoro-1,2-dithiol-3-one; N-4-dihydroxy-alpha-oxobenzene-ethanimidoyl chloride; methylene-bis-thiocyanate; dodecylguanidine hydrochloride; sodium 2-pyridinethiol-1-oxide; trihaloalkyl sulfone; bis (trichloro methyl) sulfone (BTCMS), chlorhexidine; polyhexamethylene biguanide (PHMB), glutaraldehyde, a mixture of 5-chloro-2-methyl-4-isothiazolin-3-one+2-methyl-4-isothiazolin-3-one and derivations, homologues and combinations thereof.

The method and delivery of biocides to pulp for mold resistance in paper stock for use in insulation products can vary. The proposed biocide compositions can be gelled in accordance with U.S. Pat. Nos. 5,266,217 and 5,266,218, made into water based compositions, as suggested in U.S. Pat. No. 5,312,841 or left in a solvent-based state. They can be provided in liquid or powder form. Biocides can be added to pulp and paper systems at a rate of at least about 0.05 lbs. per ton of dry fiber produced (or at least about 3 ppm of dry product), preferably within a broad range of about 0.05 to about 20 lbs. per ton of dry fiber produced (or about 3-1,000 ppm of dry product). More preferably the biocide is added in a lower range of approximately 0.025 to 1.5 lb. (3 to 180 ppm) per 1,000 gallons of pulp and water, or at a rate of 0.025 to 1.5 lb. per ton of pulp or paper produced. Ideally, the biocide is added to provide a weight in the paper of about 3-1000 ppm, and more preferably, about 3-180 ppm.

The biocides can be added to the pulp and paper system used to make the preferred facing layer 17 directly and repeated as necessary, or can be added on a continuous basis. The biocide can, for example, be applied to stock tank, flow box, furnish, wet lap, size press, water box, the hydropulper, dump chest, or a combination of these locations of a paper processing facility. Another method for applying mold resistant amounts of biocide to paper product is to add it directly to the paper stock to be preserved prior to manufacturing the finished product, i.e. added to the pulp, broke, polymer, de-foamers, alum, emulsions, adhesives, paper mill coatings, pigment slurries and paper products themselves.

The present invention prefers a particular biocide: Spectrum® RX 3100, (Hercules, Inc.) employing methyene-bis-thiocyanate and dodecylguanidine hydrochloride as active ingredients. This biocide, when added to a wet paper pulp environment, results in an antimicrobial level in the dry Kraft paper or cellulosic facing sufficient to pass ASTM C-1338 with no growth observed.

Fungicidal Effectiveness

In order to test the effectiveness of the increased use of biocide on the cellulosic facing's resistance to fungi, 44,000 pound master rolls of Kraft paper, with a biocide loading of 3-6 ppm and 12-24 ppm, was used. This was achieved by employing a level of Spectrum® RX3100 of 90 grams and 360 grams per 44,000 pounds of paper (dry weight), respectively. No adverse safety, health, process or environmental issues were reported by the paper supplier, Canfor, Ltd. Evaluations were made following the ASTM C1338 standard test method for determining fungi resistance of insulation materials and facings. The following results were obtained:

TABLE I
ASTM: C-1338-00 Fungal Resistance of Insulation
Materials and Facings

| ITEM | A | B | C | RESULTS |
|---|---|---|---|---|
| Canfor Kraft Paper with 3-6 ppm | NGO | NGO | NGO | PASS |
| Paper Sent to CertainTeed | | | | |
| Feb. 10, 2002 | | | | |
| Canfor Kraft Paper with 12-24 ppm | NGO | NGO | NGO | PASS |
| Paper Sent to CertainTeed | | | | |
| Feb. 10, 2002 | | | | |

NGO No growth observed
++ Growth exceeding Reference Control
+ Growth
−+ Doubtful growth

A review of these results establishes that the composition of the present invention (the Canfor Kraft paper items) gave acceptable rates of kill, even at low biocide concentration levels (about 3-6 ppm) in the Kraft facing. This is well below the label recommended dosage for RX-31 (new RX3100) of 5.0 to 20.0 pounds per ton of dry fiber produced, or 200 to 1000 ppm of biocide in the sizing solution applied to the paper sheet for mold inhibition in paper and paperboard. The ability of using an existing biocide treatment in a paper and pulp process to achieve the additional goal of mold or fungi resistance in building insulation is very cost effective, since material costs remain generally low in the quantities employed, and labor costs are not significantly increased.

From the foregoing it can be realized that this invention provides improved building insulation with antifungal and antimicrobial facing. The facing can be rendered antifungal or antimicrobial with little increased cost, preferably by the artful selection and dosage of the biocide used in connection with the process for making a pulp precursor of the cellulosic facing to achieve enhanced mold resistance, and preferably, acceptable testing under ASTM C1338. Although various embodiments have been illustrated, this is for the purpose of describing and not limiting the invention. Various modifications, which will become apparent to one skilled in the art, are within the scope of this invention described in the attached claims.

1. A building insulation comprising:
a cellulosic facing, comprising at least one antifungal/antimicrobial agent present in an amount in weight of less than 200 ppm; and
an insulation layer adhered to said cellulosic facing by an adhesive, said insulation layer comprising randomly oriented inorganic fibers bonded together with a binder.

2. The building insulation of claim 1 wherein said antifungal/antimicrobial agent is nontoxic and noncarcinogenic when said facing is contacted by humans.

3. The building insulation of claim 1 wherein said antifungal/antimicrobial agent is heat resistant to a temperature of at least about 250° F.

4. The building insulation of claim 1 wherein said antifungal/antimicrobial agent is heat resistant when contacted with molten bituminous adhesive; and
said insulation layer is bonded to said cellulosic facing with a bituminous adhesive.

5. The building insulation of claim 1, wherein the cellulosic facing is Kraft paper.

6. The building insulation of claim 1, wherein said cellulosic facing has a basis weight of about 20-60 lbs. per 3000 ft².

7. The building insulation of claim 1, wherein said antifungal/antimicrobial agent comprises one or more of the following: chlorine, organo-mercurials, chlorinated phenols, organo-bromides, organo-sulphur compounds, copper sulfate, 2, 4, 4′-trichloro-2′ hydroxydiphenol, 5-chloro-2-(2, 4 dichlorophenoxy) phenol; diiodomethyl-p-tolylsulfone; 2-bromo-2 nitropropane-1,3-diol (BNPD); sodium 2-pyridinethiol-1-oxide (PEO); 2-(thiocyano-methyl thio) benzothiazole (TCMTB), 3-iodo-2 propynyl-butyl carbamate; phenyl-(2-cyano-2 chlorovinyl) sulfone; N,N-dimethyl-N′-phenyl-(N′-fluorodichloromethylthio) sulfamide; 2,2-dibromo-2-nitrilopropionamide; 3,4-dicholoro-1,2-dithiol-3-one; N-4-dihydroxy-alpha-oxobenzene-ethanimidoyl chloride; methylene-bis-thiocyanate; dodecylguanidine hydrochloride; sodium 2-pyridinethiol-1-oxide; trihaloalkyl sulfone; bis (trichloro methyl) sulfone (BTCMS), chlorhexidine; polyhexamethylene biguanide (PHMB), glutaraldehyde, a mixture of 5-chloro-2-methyl-4-isothiazolin-3-one+2-methyl-4-isothiazolin-3-one and derivations, homologues and combinations thereof.

8. The building insulation of claim 1, wherein said insulation has a R-value of between 5 and 100.

9. The building insulation of claim 1, wherein said insulation passes ASTM C1338 when exposed to a microorganism.

10. The building insulation of claim 1, wherein said antifungal/antimicrobial agent presents no significant toxic residue on said cellulosic facing.

11. (canceled)

12. The building insulation of claim 4, wherein said antifungal/antimicrobial agent is present in said cellulosic facing in a level of about 3-180 ppm.

13. The building insulation of claim 4 wherein said antifungal/antimicrobial agent is added to the furnish pulp used to make said cellulosic facing.

14. A building insulation comprising a cellulosic facing, comprising at least one antifungal/antimicrobial agent added to the furnish pulp used to make said cellulosic facing in a quantity of less than 200 ppm based on the dry weight of the cellulosic facing, but high enough to render said facing mold resistant in accordance with ASTM C1338; and
an insulation layer adhered to said cellulosic facing by an adhesive, said insulation layer comprising randomly oriented inorganic fibers bonded together with a binder.

15. The building insulation of claim 14, wherein said cellulosic facing is Kraft paper having a basis weight of about 20-60 lbs. per 3000 ft.².

16. The building insulation of claim 15, wherein said Kraft paper has a bituminous vapor barrier coating thereon.

17. The building insulation of claim 16, wherein said antifungal/antimicrobial agent is resistant to a temperature of at least about 250° F.

18-37. (canceled)

38. A building insulation batt comprising:
a cellulosic facing comprising at least one antifungal/antimicrobial agent present in an amount in weight of less than 200 ppm wherein the antifungal/antimicrobial agent is nontoxic and noncarcinogenic when contacting the skin of a human being; and
an insulation layer adhered to said cellulosic facing by an adhesive, said insulation layer comprising randomly oriented inorganic fibers bonded together with a binder.

39. A building insulation comprising:
a cellulosic facing comprising at least one antifungal/antimicrobial agent present in an amount in weight of less than 200 ppm, which is heat resistant to a temperature of at least about 250° F.; and
an insulation layer bonded to said cellulosic facing with an adhesive, said insulation layer comprising randomly oriented inorganic fibers bonded together with a binder.

40. A building insulation comprising:
a cellulosic facing comprising at least one antifungal/antimicrobial agent present in an amount in weight of less than 200 ppm, which is heat resistant when contacted with molten bituminous adhesive; and
an insulation layer bonded to said cellulosic facing with a bituminous adhesive, said insulation layer comprising randomly oriented inorganic fibers bonded together with a binder.

41. A facing for an insulation product, comprising a Kraft paper having adhered to a first surface thereof by a bituminous adhesive, said Kraft paper containing a biocide in the amount in weight of less than 200 ppm, which is effective in achieving no observable fungi or mildew growth when tested in accordance with the ASTM C-1338 test method.
